(19) United States
(12) Patent Application Publication
(10) Pub. No.: US 2008/0263832 A1
(43) Pub. Date: Oct. 30, 2008

(54) Reactor for Mixing and Reacting Two or More Fluids As Well As Transferring Heat Between Said Fluids and a Method for Operating Said Reactor

(75) Inventors: Tor Bruun, Porsgrunn (NO); Bjornar Werswick, Langesund (NO); Knut Ingvar Asen, Porsgrunn (NO); Terje Fuglerud, Porsgrunn (NO)

Correspondence Address: WENDEROTH, LIND & PONACK, L.L.P., 2033 K STREET N. W., SUITE 800, WASHINGTON, DC, 20006-1021, US

(73) Assignee: NORSK HYDRO ASA, Oslo (NO)

(21) Appl. No.: 11/887,223

(22) PCT Filed: Jun. 21, 2006
(86) PCT No.: PCT/NO2006/000236

§ 371 Date: Dec. 12, 2007

(30) Foreign Application Priority Data
Jul. 1, 2005 (NO) 200553257

(51) Int. Cl. B01J 19/00

(52) U.S. Cl. 23/293 R; 422/224; 422/211

(57) ABSTRACT

The present invention relates to a reactor for mixing and reacting two or more fluids as well as transferring heat between said fluids. Said reactor comprises a pressure vessel (g) having at least one inlet and one outlet and which enclose a multi-channel monolithic structure (f), a manifold assembly (b) sealed to one end of said structure where the channel openings are, for feeding fluid to said structure and discharging fluid from said structure, a means (h) sealed to the opposite end of said structure where said manifold assembly is sealed, for changing the direction of fluid flow path 180 degrees when said flow leaves the channels in said structure. Furthermore, the present invention relates to a method for operating said reactor.

The present invention relates to a reactor for mixing and reacting two or more fluids as well as transferring heat between said fluids. Furthermore, the present invention relates to a method for operating said reactor.

A system well known from the literature, that has the ability to combine counter-current flows and heat integrated reaction within a same structure, is the “swiss roll” system as described in U.S. Pat. No. 6,613,972. A hot reaction zone is in the centre of the “swiss roll” where an inlet flow changes its flow path to an outlet or effluent flow containing the reaction products. Such a system has the ability to reduce heat losses compared to a conventional system.

The “swiss roll” reactor uses flameless catalytic combustion to burn an air/fuel mixture. The counter-current operation allows the reactor to operate with relatively low temperature on the inlet and the outlet flow. Such a recuperative self-stabilising system is characterized as “excess enthalpy combustion”. The following favourable points are reported:
Thermal energy transfer mechanism to preheat the reactants using the exhaust heat
Combustion volume (possibly pressurized)
Relatively large internal surface/volume ratio needed for the heat transfer through the walls and for effective action of the catalyst
Relatively large top and bottom surface area for the heat transfer to external devices

Another structure that has the ability to operate similar to the “swiss roll” structure is a multi-channel monolithic structure. However, said structure is not applicable due to lack of a method and device that makes it possible to change the flow path in said structure.

Monoliths have been utilised by the car industry since the early seventies. In 1970, the US Clean Air Act called for a reduction of polluting gases from car exhaust by 90% in 5 years. A catalytic surface coated shaped honeycomb or monolithic structure with a large number of small parallel channels was then introduced to convert gases like NOx and CO to more environment friendly products. Today catalyst-coated monoliths are installed as exhaust gas converter in cars through out the world and are said to be the world's most widespread reactor.

Monolithic reactor systems of today like the car exhaust converters operate only with single flow reaction systems. This means that a mixed gas is fed into the channel openings in one end of the monolithic structure at a temperature high enough to initiate a reaction between one or more components of the gas when the gas components come into contact with the catalyst coated on the channel walls. The reaction products will then leave the channels in the other end, i.e. opposite to the inlet. In such a system of simultaneous single flow, no mixing, mass and/or heat transfer between the fluids in the different channels (same fluid in all channels) can be performed.

The potential use of monolithic honeycomb based structures for compact combined heat exchanger reactors have been known for a relative long period. Whereas the monolithic exhaust gas converter has the same gas entering all the channels so have the heat exchange reactor two different gases in separate channels. U.S. Pat. No. 4,101,287 describes such a reactor were both ends of the monolith have manifolds to form separate entrances to channels of different groups for two fluids (fluid 1 and fluid 2), allowing heat conduction from the fluid in one group of the channels to the fluid in the other group of the channels. In U.S. Pat. No. 4,101,287 the arrangement of group of channels are in a linear pattern and thus only two of the four walls of the channels separate gases of the same group. Thus the two remaining or 50% of the monolith walls are active with respect to heat exchange between gases of different groups.

In WO 04/090451 (Norsk Hydro) a manifold system is described with capability of feeding two different fluids in and out of the channels of a monolithic structure enabling 100% internal wall surface area utilisation. The channel openings are evenly distributed over the entire cross-sectional area of said structure as in a chessboard pattern where the first fluid (fluid 1) flows in the “black” channels and the second fluid (fluid 2) flows in the “white” channels. Thus a channel with one group of fluid will always have channel walls that are common with the channels of the other group of fluid and thus all walls can be active and used for mass and/or heat transfer between the two groups of fluid. The entrance of fluid 1 and fluid 2 can be in the same end of the monolith (co-current flow) or in the opposite ends of the monolith (counter-current flow).

However, the fluid with entrance in one end of the monolith will always have its outlet in the opposite end of said monolith, and the channel walls will always separate fluid 1 and fluid 2.

Large reactor systems for different process systems can be constructed by using the multi-channel monolithic structures as described in WO 04/090451. This is due to the fact that a scale up can be done by combining two or more units.

In principle monoliths can be produced of a wide variety of materials, but the preferred choice is ceramics. This is due to the reason that ceramics can be mass-produced by the extrusion technique at a relatively low price. In addition ceramic monoliths can tolerate high temperatures, have high strength and combine low pressure drop with large surface to volume area. The channel walls in said monoliths can be coated with a catalyst with different components and thus have the flexibility towards operating with different process systems.

Reforming of natural gas to produce a mixture of carbon monoxide and hydrogen (i.e. syngas) is one of the most interesting processes for the application of large surface area structures like the multi-channel monolith. Steam or auto thermal reforming produces a mixture of hydrogen and carbon monoxide. The synthesis gas can then be further reacted by different routes to produce bulk chemicals like ammonia, methanol and synthetic diesel. Alternatively hydrogen can be separated as product for example by the commercial pressure swing adsorption (PSA) method.

The following reactions are essential in the reformation of natural gas:

CH₄+H₂O=3H₂+CO Steam methane reforming (SMR) I

CH₄+0.5O₂=CO+2H₂ Partial oxidation (POx) II

CO+H₂O=CO₂+H₂ Water gas shift reaction (WGS) III

The steam methane reforming reaction is highly endothermic and normally a part of the natural gas or hydrocarbon rich off gases is combusted to produce the necessary heat. Industrial practise of today is to heat metallic pipes filled with catalyst coated pellets and let the steam methane mixture flow through these pipes in contact with the catalyst. The pipes are heated by means of gas flames directed onto the outer pipe wall and transferred to the endothermic SMR reaction. The SMR reaction normally takes place at 20-30 bars and 800-900° C. The gas flames operate in air at atmospheric conditions and thus an exhaust containing the greenhouse gas carbon dioxide is produced when a hydrocarbon rich fuel like natural gas is used.

The other main industrial process used for reforming of natural gas to synthesis gas is the auto thermal reforming process (ATR). This process produces no external exhaust gas. The heat is produced internally in the process by first oxidising part of the natural gas to produce heat. This heat is then utilised by the slower and catalyst enhanced SMR reaction. In principle the heat produced by the oxidation shall directly be balanced by the steam methane reforming reaction giving an auto thermal reforming process. An auto thermal reformer generally operates at a temperature around 800-900° C. and at pressure around 30-40 bars.

Many processes, like the SMR have their optimum process conditions at temperatures above 800-900° C. where use of metals are not recommended due to the fact that metals loose their strength at such high temperatures. The high outlet temperature of the SMR and ATR is requiring a high heat exchange capacity after the reforming step to cool outlet product gases. For example the catalyst enhanced water gas shift reaction that is performed downstream of the reforming step at temperatures in the range of 200-300° C. At high temperature and high CO₂/CO ratio there is a risk that metal dusting can occur according to the well-known Boudard reaction. It is further a challenge to integrate the endothermic reforming reactors and the heat exchange between reactants, products, air and exhaust without extensive energy losses.

Thus, a disadvantage of the prior art technology is that incoming fluid flow with reactants must be preheated externally of the reactor to a temperature high enough to ensure start of the reaction when entering the reaction chamber. Alternatively an internal ignition system is needed, like in the swiss roll concept, to control the reaction start. This external preheat procedure is uneconomic and an inefficient way of raising the reaction temperature. Another major disadvantage of the prior art is the very low compactness of these reactor systems. Typically a surface to volume area of 50-100 m²/m³ is available in a conventional gas fired steam methane reformer. A monolithic based reformer with channel sizes in the range of 1-2 mm has approximately ten times more surface area available for heat exchange and thus a much more compact reactor system can be designed.

Furthermore, the possibility of mixing in a third fluid, or even more fluids, to perform a reaction within the channels of a monolithic structure has not been shown by the prior art.

The present invention seeks to provide a compact, economic and energy efficient reactor, and a method for operating said reactor, for mixing and reacting two or more fluids as well as transferring heat between said fluids.

In accordance with the present invention, these objects are accomplished in a reactor where said reactor comprises a pressure vessel g having at least one inlet and one outlet and enclosing a multi-channel monolithic structure f, a manifold assembly b sealed to one end of said structure where the channel openings are for feeding fluid to said structure and discharging fluid from said structure, a means h sealed to the opposite end of said structure where said manifold assembly is sealed for changing the direction of fluid flow path 180 degrees when said flow leaves the channels in said structure.

Furthermore, these objects are accomplished by a method for operating said reactor where said method comprises the following steps: a fluid 1 is fed to said manifold assembly and flows into one or more channel openings in one end of said monolithic structure and further into one or more channels in said structure wherein components in said fluid flow perform an endothermic reaction resulting in a product stream flowing out of the channel opening at the opposite end of said structure, said stream turns 180 degrees and flows into an adjacent channel opening in said structure now as fluid 2, fluid 2 flows through said adjacent channels counter-current to said fluid 1 wherein components in said fluid 2 perform an exothermic reaction resulting in a hot product stream, heat produced by said exothermic reaction is transferred through the channel walls to heat said fluid 1, said product stream (fluid 2) flows out of said channel at the same end of said structure as fluid 1 enters said structure.

A much more economic and efficient way of heating reactants is to use heat from hot reactant gases to heat and perform an endothermic reaction within the reactor itself. In the present invention the inlet fluid flow with components performing an endothermic reaction is heated by the resulting heat of reaction from an exothermic reaction after injection of a fluid with components that can initiate or trigger the exothermic reaction. The exothermic and endothermic reaction takes place inside channels of a multi-channel monolith. These channels can be catalyst coated to ensure that the desired reactions take place. A part of latent heat of the reaction can be transferred from the reactants of the hot outlet fluid 2 to the cold inlet fluid 1. Furthermore, the inlet fluid 1 and the outlet fluid 2 will be entering and leaving the monolith manifold at their coldest temperature level enabling an energy efficient operation. The reaction system should be selected such to give the most beneficial energy balance and operating conditions.

The present invention describes how a multi-channel monolithic structure with a manifold system can be designed to perform the above-described ability.

Such an internal heat exchange, within a monolith structure between different group of fluid channels performing endothermic and exothermic reaction systems have the additional advantage of cooling down the effluent gases so that the gas handling downstream of the reactor is further simplified. The most efficient heat transfer is obtained by counter-current flow.

Another aspect of an economic reactor design is the compactness of the reactor itself. By using multi-channel monolithic structures and distributing inlet (feed) and outlet flow (effluent) in the channels according to a checkerboard pattern with one fluid in the “black” channels and the other fluid in the “white” channels a large surface to volume area can be achieved. Furthermore, the channel walls of these structures can be coated with a catalyst and thus the reactions can be controlled to a larger extent than in a reactor without catalyst coating.

To enable counter-current flow between feed flow and effluent flow there must be a means in said device (reactor) that change the direction of the feed flow path 180 degrees such that the feed flow becomes the effluent flow. Said means is a cap sealed to the opposite end of the monolithic structure as the manifold is sealed.

Furthermore, the exothermic reaction must take place such that the heat of the reaction from the hot effluent/products can be transported to the incoming feed flow.

In principle a heat exchange and a reaction scheme as mentioned above can be performed by using a feed stream containing all the necessary reactants to perform an exothermic reaction.

In principle such a system can operate without injection of a third fluid (fluid 3). However, said system must have a feed flow (fluid 1) containing the necessary components, e.g. both oxygen and fuel, and the temperature must be controlled in such a way that the heat producing reaction does not start too early. That means that the heat producing reaction and the heat consuming endothermic reaction must be controlled to take place at the most beneficial axial channel position in the monolith.

By injecting a third fluid, fluid 3, the reaction start can be controlled. However, the disadvantage will be that the reactor feed system becomes somewhat more complicated due to the fact that such a reactor must be designed with two inlet flows (fluids 1 and 3) and one outlet or effluent flow (fluid 2) compared to only one inlet and one outlet flow in the case where the mixed inlet flow is containing a mixture of e.g. oxygen and fuel.

The third fluid, fluid 3, is injected directly into the effluent flow/fluid 2, e.g. by means of nozzles located in said cap.

The nozzles must have a cross-sectional area less than the cross-sectional area of the channels in the monolithic structure. The position of the nozzles must be such that they enable the injected fluid flow to be effectively injected into said channels and mixed with the fluid in the channels. The nozzles have the ability to inject the third fluid to a pressure above the pressure internally in the channels.

The outlet fluid flows counter-current with the inlet fluid.

By utilizing only one manifold system for both the inlet flow (fluid 1) and the outlet flow (fluid 2) in one end of a multi-channel monolithic structure, and a cap in the opposite end of the monolith which is able to change the direction of the inlet flow path 180 degrees, a compact, economic and energy efficient reactor is obtained.

The monolithic structure can be made of ceramic and this could be a major advantage since many reaction systems operate at high temperature. Ceramics are further not exposed to metal dusting or hydrogen embrittlement that can be a problem in many metallic based reactor applications. An important feature of the present invention is that the manifold will have the lowest temperature of the reactor and potentially this temperature can be several hundreds degrees lower than the reaction temperature inside the channels. Thus, by using proper sealing materials the monolith can be made of ceramics while the manifold itself can be made of metal. This may give a stronger and more economical design than having all units made of ceramics. The cap for the injection of the third fluid may also be made of metal, even though it is positioned close to the reaction zone. This is due to the fact that the third fluid can have a cooling effect enabling to keep the temperature at a level where metal cap can be used.

The present invention will be further described with reference to the accompanying drawings in which:

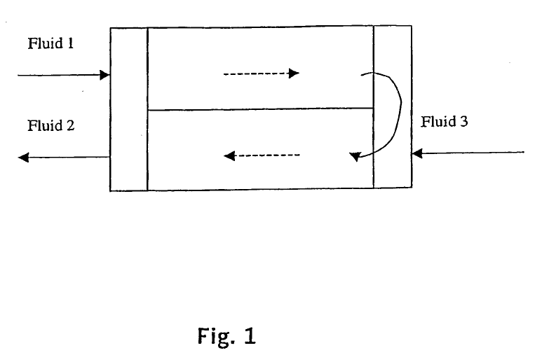

FIG. 1 shows a principle sketch of a monolithic based reactor according to the present invention.

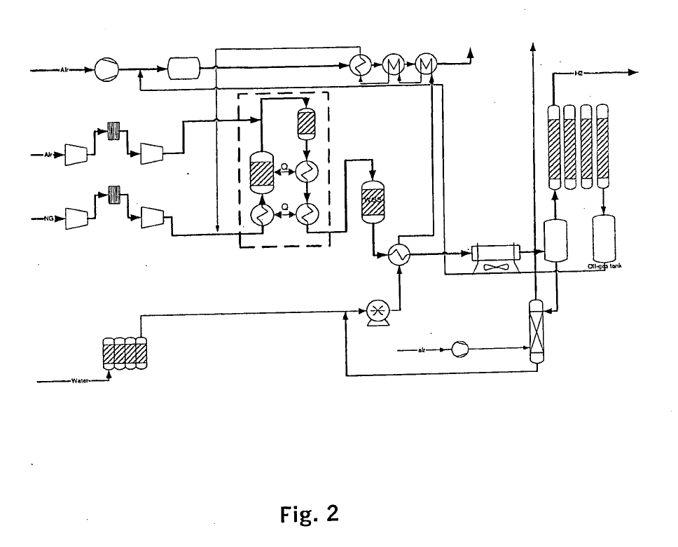

FIG. 2 shows a flow sheet for a conventional small-scale hydrogen production process.

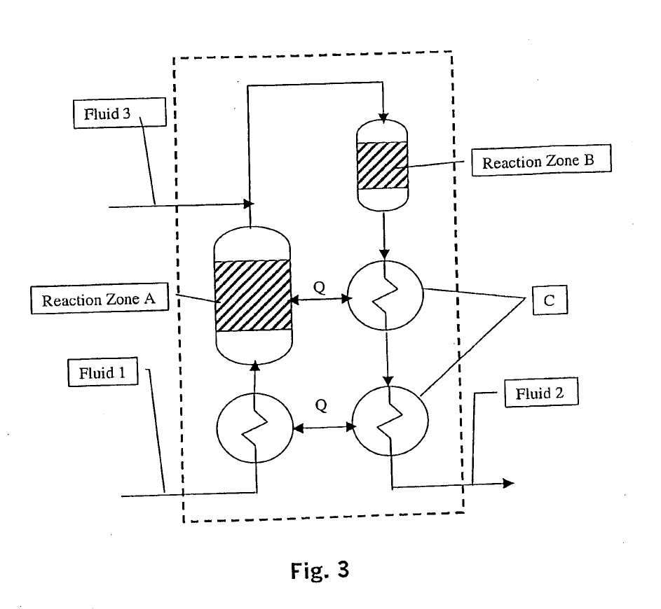

FIG. 3 shows a principal sketch of a conventional reactor system.

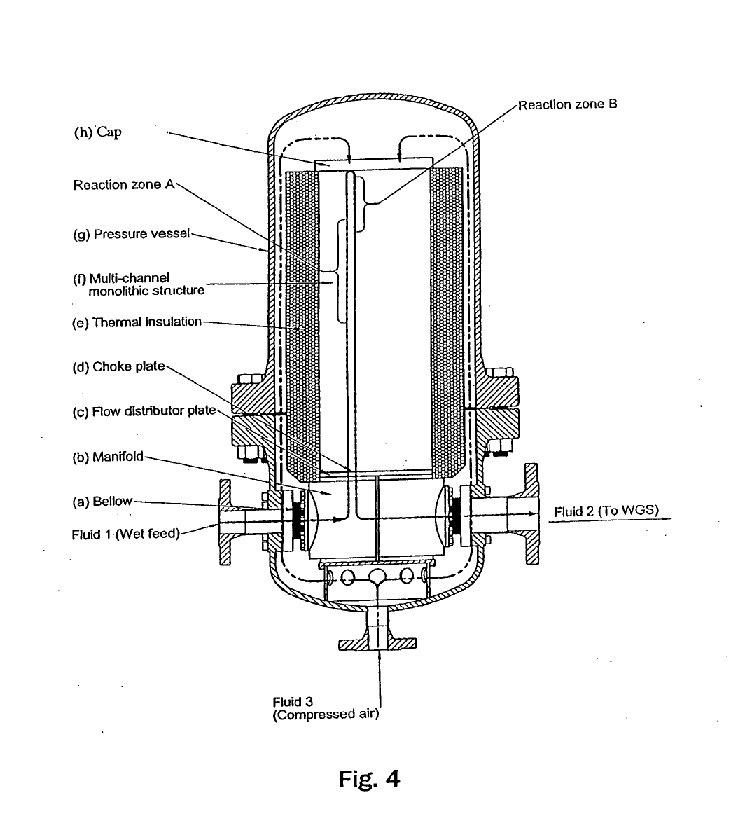

FIG. 4 shows a reactor design according to the present invention.

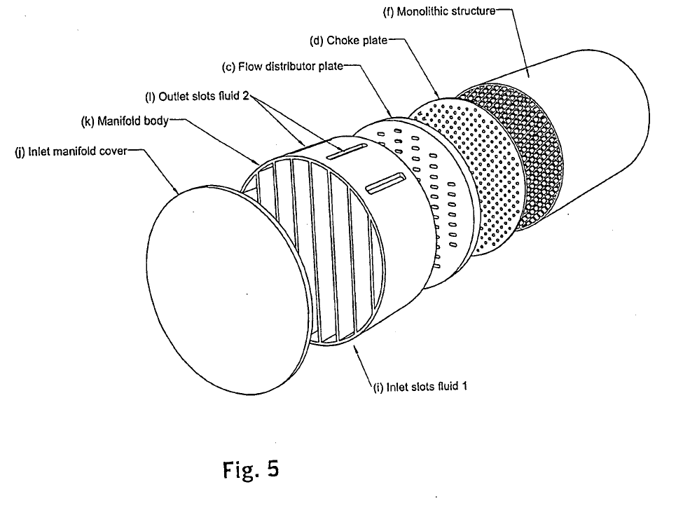

FIG. 5 shows the different parts of the manifold according to the present invention.

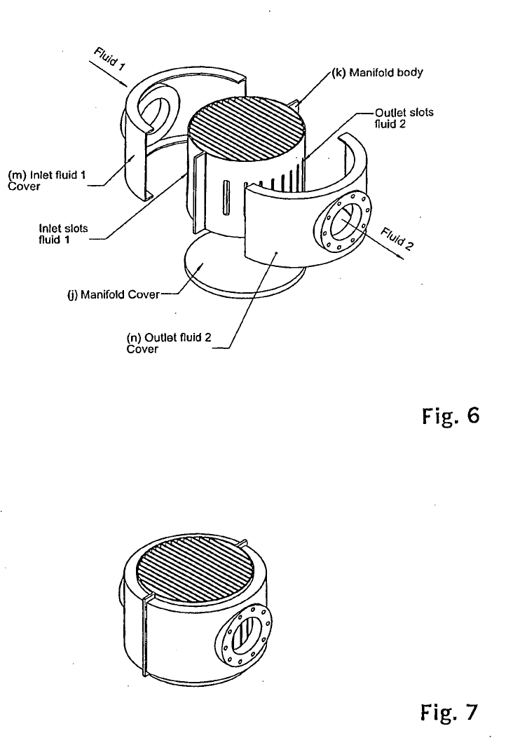

FIGS. 6 and 7 show a manifold assembly according to the present invention.

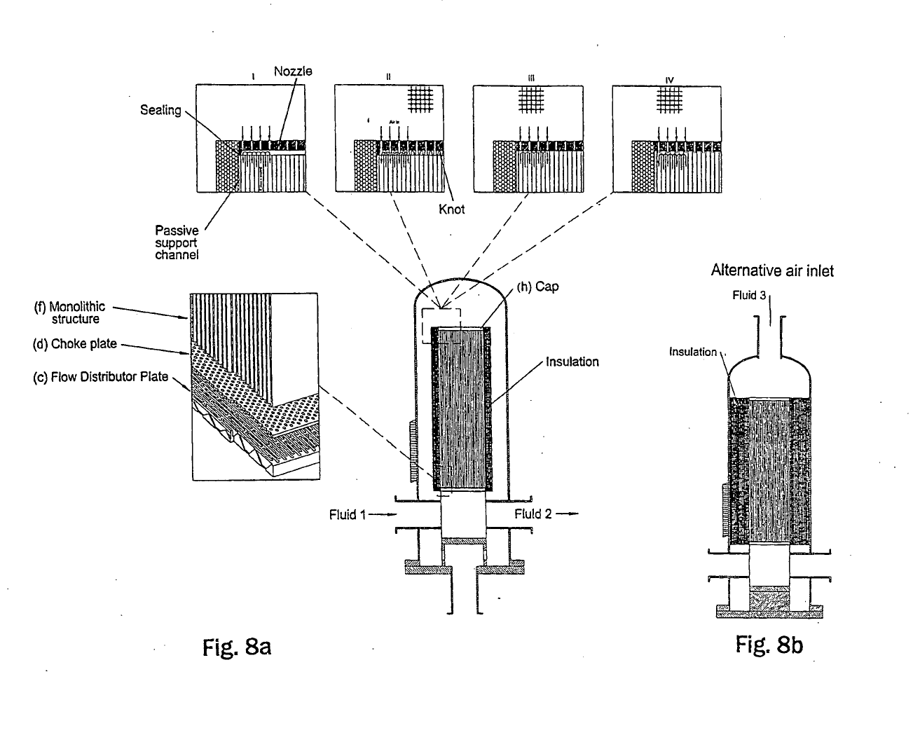

FIG. 8a shows a sketch of a reactor according to the present invention with four different solutions for support of the cap.

FIG. 8b shows an alternative reactor configuration according to the present invention with an alternative inlet for the third fluid.

In FIG. 1 an inlet fluid (fluid 1) is entering one or more channel openings in a monolithic structure, flows through the channel and out of the opening at the end of said channel where it turns 180 degrees and flows into adjacent channels in said structure now as fluid 2. Fluid 2 flows counter-current to fluid 1. Fluid 2 flows out of the channels at the same end as fluid 1 flows into the channels.

Optionally, a third fluid (fluid 3) can be fed into the same end of the monolithic structure as fluid 2 is fed and mixed with fluid 2. Fluid 3 is preferably containing one or more components that will start an exothermic reaction with one or more components of fluid 2. Fluid 1 is heated through the channel wall in said structure by heat produced by the exothermic reaction. This heat transferred from fluid 2 may preferably be utilized to initiate and enhance an endothermic reaction between one or more components of fluid 1. Thus a direct heat transfer between the outgoing heat producing fluid 2 and the incoming heat receiving fluid 1 is obtained.

FIG. 2 shows a typical flow sheet for small-scale hydrogen production well known for those skilled in the art. The reactor system marked by the stapled line has two feed streams and one product or effluent stream. The first feed stream (fluid 1) is a mixture of pressurized natural gas (NG) and steam. Steam is made by heat produced from burning the rest (off) gas from the pressure swing adsorption process (PSA) used to separate the hydrogen from CO₂ in the product gas. The other feed stream (fluid 3) is compressed air. The resulting product or effluent gas leaving the reactor (fluid 2) is sent to the water gas shift reactor (WGS) where carbon monoxide reacts with water vapor to produce more hydrogen. FIG. 2 shows WGS outside the boarder (stapled line) of the reactor system, but an option could be to perform WGS in the outlet channels of the monolith and thus move the WGS reaction inside the reactor system boarder line.

FIG. 3 shows a more detailed description of the reactor system in FIG. 2. The mixture between hydrocarbon rich gas and steam (fluid 1) is first heated by transferring heat from the effluent gas as shown by arrows and the letter “Q”. The heated mixture of steam and gas is sent to the first reaction zone marked by the letter “A”. In this first reaction zone natural gas and steam reacts according to the well-known steam methane reforming (SMR) reaction producing carbon monoxide and hydrogen. The SMR is an endothermic reaction, and to ensure continuous reaction heat must be transferred from a heat producing or exothermic reaction to the endothermic SMR reaction. Injection of air (fluid 3) gives available oxygen such that an exothermic reaction can be performed with the hydrogen rich product gas from reaction zone A. A major part of the resulting heat “C” from the exothermic reaction zone B is transferred to the endothermic reaction zone A as symbolized by arrows marked with Q. By such a counter-current system and balancing heat transfer between endo- and exothermic reactions an auto thermal operation can be performed. With the reactor of present invention the effluent fluid 2 has the potential of leaving reactor at a temperature slightly above the inlet fluid 1 temperature.

FIG. 4 shows a reactor according to the present invention that replaces the reactor system as shown in FIGS. 2 and 3. The reactor comprises a pressure vessel g including a multi-channel monolithic structure f and a manifold b sealed to one end of said structure where the channel openings are. Said openings are evenly distributed over the entire cross-sectional area of said monolithic structure as in a chessboard pattern. Fluid 1, e.g. a mixture of steam and hydrocarbon rich gas (natural gas), is fed through a bellow a, in to the manifold b, through a flow distributor plate c and a choke plate d enabling a “chess pattern” flow in the multi-channel monolith structure f. When leaving a channel opening in the opposite end of said structure fluid 1 turns 180 degrees by means of a cap h and flows in to an adjacent channel now as fluid 2. Said cap is sealed to the opposite end of said structure as the manifold is sealed.

Optionally, a fluid 3, e.g. compressed air, is fed through a bottom flange and flows upward along the inside of the wall of the pressure vessel and through nozzles in said cap hand in to the channels where fluid 2 flows (downward flow in FIG. 4). The nozzles must have a cross-sectional area less than the channel cross-sectional area and the position of the nozzles must be such that the injected fluid 3 flow enters into the fluid 2 flow prior to reaction zone A. Fluid 3 is mixed with fluid 2 at the cap h end. Thus, the resulting fluid 2 flows counter-current to inlet fluid 1. The fluid 2 is entering the exothermic reaction zone B after mixing with fluid 3. The exothermic reaction is must faster than the endothermic reaction performed in zone A. Thus heat will be transferred to the endothermic reaction mainly from the hot reaction product fluid downstream of reaction zone B. The product fluid will thus be cooled down first by transporting heat to the endothermic reaction and secondary by giving of heat to the incoming fluid 1 downstream reaction zone A. Thus by proper design and sufficient residence time (channel length) outlet flow can be only a few degrees higher than the inlet flow. Thus the cold product fluid flow, fluid 2, can be sent directly to a water gas shift reaction when inlet flow have a temperature close to the operating temperature of the water gas shift reaction.

The manifold and the cap should enable evenly distribution of the fluid over the entire cross-sectional area of said structure for maximum utilizing the available heat exchange surface area of the monolith. Even though temperatures of 1000° C. or more can be present in the monolithic structure due to exothermic reaction, the manifold end of the monolith can be kept at a temperature many hundred degrees lower enabling the manifold to be made of a metallic materials. The cap can be made of metallic material as it will be cooled by fluid 3 and kept some distance from the exothermic reaction zone.

FIG. 5 shows a view of the different parts of the manifold as shown in FIG. 4. As can be seen in FIG. 5 the manifold body k internally consists of plates. Inlet fluid 1 and outlet fluid 2 are directed to the enclosed room between these plates such that the plate wall separates fluid 1 and fluid 2. Thus every second room or space is for fluid 1 and vice versa for fluid 2. To keep fluid 1 and fluid 2 separated outside the manifold body fluid 1 and fluid 2 are let in and out through enclosed rooms made by the manifold covers j, m and n as shown in FIG. 6. These covers are made with circular flange openings such that fluid 1 and fluid 2 can be fed in/out through pipelines.

FIG. 7 shows the manifold assembly with parts as shown in FIG. 6.

FIG. 8a shows a principal sketch of a reactor according to the present invention with four different solutions (I-IV) for support of the cap h. Also shown is an alternative reactor configuration (FIG. 8b) where a fluid 3 is injected through a flange in the top. By this configuration the whole space between the monolith and the reactor pressure vessel wall is filled with thermal insulation. Solution I shows cap h with nozzles having its support at its edges. Thus the cap is sealed against the periphery channels of the monolith. These channels have thus no active fluid transport. This solution is simple but has limited strength against pressure differences across the cap. The fluid 3 pressure must be higher than the fluid pressure internally in the channels of the monolith. These nozzles give the injected fluid 3 a pressure drop. This pressure drop is necessary for an even distribution of fluid 3 injected in to the channels of the monolith.

In solution II the square grid shown within the frame window represents the channels of the monolith. The support points for the cap is in the channel cross point marked with black dots. The support points can be made by having “knots” or “buds” resting on the cross grid of the monolith channels. These “knots” may be elevations on the cap or any other solution capable of making some distance between the cap and the monolith with supporting points in the cross points of the square channels of the monolith.

In solution III the cap is supported directly to the cross points of the monolith. To ensure the 180 degree turning and free flow from fluid 1 channels to fluid 2 channels part of the walls in the end directed at the cap must be removed. This is shown in the drawing by having a thinner line symbolizing the channel wall. In the grid system this is shown by grey color of the part of the walls that is removed and black color on the part of the wall that is kept.

Solution IV shows a variant of solution Ill. Tubes sealed in to cap make the difference from the solution III. By having such tubes fluid 3 flow can be directed a longer distance in to the fluid 2 channels. This solution has the potential for giving a better and more efficient mixing between fluid 2 and fluid 1.

By the present invention a compact, economic and energy efficient reactor, and a method for operating said reactor, for performing mixing, reaction and heat transfer between two or more fluids have been obtained. The present invention makes it possible to change the flow path inside a monolithic structure. Furthermore, the present invention demonstrates a potential for small scale as well as large-scale industrialised production. This is due to the fact that scale up can be done by a modularised system. Another feature of present invention is the flexibility towards operating with different process systems.

Reforming of natural gas to produce a mixture of carbon monoxide and hydrogen (i.e. syngas) is one of the most interesting processes for the application of the present invention. The synthesis gas can be further reacted by different routes to different chemicals or bulk products like ammonia, methanol and synthetic diesel. Alternatively hydrogen can be separated from the syngas for example by the commercial pressure swing adsorption (PSA) method.

Also combustion of lean hydrocarbon gases or other combustable offgases can be performed by the present invention due to the ability of direct heat transfer from the combustion zone to the incoming fluid (i.e. reactants).

1-17. (canceled)

17. A reactor for mixing and reacting two or more fluids as well as transferring heat between said fluids, said reactor comprising:
a pressure vessel (g) having at least one inlet and one outlet and enclosing a multi-channel monolithic structure (f);
a manifold assembly (b) sealed to one end of said structure where the channel openings are for feeding fluid to said structure and discharging fluid from said structure; and
a means (h) sealed to the opposite end of said structure where said manifold assembly is sealed for changing the direction of fluid flow path 180 degrees when said flow leaves the channels in said structure.

18. A reactor according to claim 17, wherein said means is a cap.

19. A reactor according to claim 17, wherein said channel openings are evenly distributed over the entire cross-sectional area of said monolithic structure.

20. A reactor according to claim 17, wherein said pressure vessel encloses a bellow (a) connected to said manifold assembly (b).

21. A reactor according to claim 17, wherein said pressure vessel encloses a flow distributor plate (c) and a choke plate (d) enabling “chess pattern” flow in said multi-channel monolithic structure (f).

22. A reactor according to claim 17, wherein at least one of said channel walls are coated with a catalyst.

23. A reactor according to claim 18, wherein said cap comprises nozzles for feeding a fluid in to said monolithic structure.

24. A reactor according to claim 23, wherein said nozzles have a cross-sectional area less than the cross-sectional area of the channels and the position of the nozzle openings must be such that said fed fluid mixes with fluid in the channels prior to a reaction zone (A).

25. A reactor according to claim 23, wherein said fluid is fed into said pressure vessel through a bottom flange and flows upward along the inside wall of said pressure vessel but outside said structure and further through said nozzles and in to said channels.

26. A reactor according to claim 17, wherein said monolithic structure is made of a ceramic material.

27. A reactor according to claim 17, wherein said manifold assembly is made of a metallic material.

28. A reactor according to claim 17, wherein said cap is made of a metallic material.

29. A method for operating a reactor according to claim 17, wherein said method comprises the following steps:
a fluid 1 is fed to said manifold assembly and flows into one or more channel openings in one end of said monolithic structure and further into one or more channels in said structure wherein components in said fluid flow perform an endothermic reaction resulting in a product stream flowing out of the channel opening at the opposite end of said structure, said stream turns 180 degrees and flows into an adjacent channel opening in said structure now as fluid 2,
fluid 2 flows through said adjacent channels counter-current to said fluid 1 wherein components in said fluid 2 perform an exothermic reaction resulting in a hot product stream,
heat produced by said exothermic reaction is transferred through the channel walls to heat said fluid 1,
aid product stream (fluid 2) flows out of said channel at the same end of said structure as fluid 1 enters said structure.

30. A method according to claim 29, wherein a fluid 3 is fed into said pressure vessel where components in said fluid start an exothermic reaction with one or more components of fluid 2 resulting in a hot product stream that flows through said channels counter-current to said fluid 1.

31. A method according to claim 29, wherein said fluids are fed in to one or more channels that are coated with a catalyst.

32. A method according to claim 29, wherein said fluids are fed in to channel openings that are evenly distributed over the entire cross-sectional area of said monolithic structure.
